(19) United States
(12) Patent Application Publication
(10) Pub. No.: US 2006/0229026 A1
(43) Pub. Date: Oct. 12, 2006

(54) Method for calibrating a wireless base station using an internal source

(75) Inventor: Michael Anthony Lynch, Denville, NJ (US)

Correspondence Address: WILLIAMS, MORGAN & AMERSON, 10333 RICHMOND, SUITE 1100, HOUSTON, TX, 77042, US

(73) Assignee: Lucent Technologies

(21) Appl. No.: 11/095,022

(22) Filed: Mar. 31, 2005

(51) Int. Cl. H04B 7/00; H04B 1/00

(52) U.S. Cl. 455/69

(57) ABSTRACT

A method is provided for controlling a radio frequency generator in a wirelss base station. The method comprises determining a first power level of a radio frequency transmission, and determining a second power level of a calibration transmission. The calibration transmission is of a known magnitude. The first power level is adjusted based on a difference between the first and second power levels.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of wireless base stations distributed within an area to be serviced by the system. Various users within the area, fixed or mobile, may then access the system and, thus, other interconnected telecommunications systems, via one or more of the base stations. Typically, a mobile device maintains communications with the system as the mobile device passes through an area by communicating with one and then another base station, as the user moves. The mobile device may communicate with the closest base station, the base station with the strongest signal, the base station with a capacity sufficient to accept communications, etc., and it may do so over one or more wireless channels.

In the wireless base stations, multiple power detection systems are typically used to perform power leveling functions, automatic gain control functions, test, diagnostic and calibration functions. Often, in order to determine reliable performance, particularly for monitoring the power level of the transmitter, multiple steps need to be performed. First, many elements within the base station's transmitter, receiver, feedback measurements, and calibration paths (such as cables, filters, couplers, and receiver elements) need to be pre-calibrated either in the factory during manufacture, or in an integration test center when the entire base station's radio frequency (RF) path is fully assembled. These calibration tables may be complex, and they are often stored in multiple memory tables. Both non-volatile memory elements internal to the RF element, such as within a pre-calibrated filter assembly for permanent memory, and also volatile memory, such as within a controller or radio, for use when the system is operational and calculating end-to-end power levels, may be used within a system. These tables may be incremented over frequency range, power level, and temperature, and perhaps over other operational parameters as well.

Even with all of this apriori data store in memory, there is still a need, either in the field, or in the integration test center, to perform a final calibration. This final calibration step typically consists of disconnecting the base station transmitter from its normal antenna and connecting it to a precision, calibrated power meter, running the transmitter at a defined level, and recording the externally measured power level. By comparing this externally measured power level with the base station's own measurement power detectors, the residual errors can then be calibrated out, stored in yet another table, and saved for later use to determine the exact transmitted power. Unfortunately, when internal cables within the base station are changed, this final calibration step must often be performed again, for the difference in the loss value for the new cable is unknown. Likewise, replacement of any other RF element that does not have an internal non-volatile calibration table may also require repetition of the final calibration step. Thus, elements that may be replaced in the field may be required to incorporate non-volatile memory within the units to reduce the need for recalibration.

The present invention is directed to overcoming, or at least reducing, the effects of one or more of the problems set forth above.

### SUMMARY OF THE INVENTION

In one aspect of the instant invention, a method is provided for controlling a radio frequency generator. The method comprises determining a first power level of a radio frequency transmission, and determining a second power level of a calibration transmission. The first power level is adjusted based on a difference between the first and second power levels.

In another aspect of the instant invention, a radio frequency generator is provided. The radio frequency generator comprises a first and second radio frequency source where the second radio frequency source is calibrated to provide a radio frequency signal having a power level of a predetermined magnitude. A receiver is adapted to determine a power level of the first and second radio frequency sources. A feedback controller is adapted to adjust the power level of the first radio frequency source based on a difference between the power levels of the first and second sources.

In yet another aspect of the instant invention, a method for controlling a radio frequency generator is provided. The method comprises transmitting a first and second radio frequency signal. The second radio frequency signal is a calibration signal having a power level of a preselected magnitude. A power level of the first radio frequency signal is adjusted based on a difference between the power levels of the first and second radio frequency signals.

### BRIEF DESCRIPTION OF THE DRAWINGS

The invention may be understood by reference to the following description taken in conjunction with the accompanying drawings, in which like reference numerals identify like elements, and in which:

FIG. 1 depicts a block diagram of a communications system, in accordance with one embodiment of the present invention;

FIG. 2 depicts a block diagram of one embodiment of a RF signal generator that employs aspects of the instant invention;

FIG. 3 depicts a stylized diagram of an RF calibrator that may be employed in the RF signal generator of FIG. 2;

FIG. 4 depicts one embodiment of a power detector that may be employed in the RF signal generator of FIG. 2;

FIG. 5 depicts a graph of RF signal power versus frequency; and

FIG. 6 depicts a flow chart illustrating the operation of a DSP/ASIC of FIG. 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

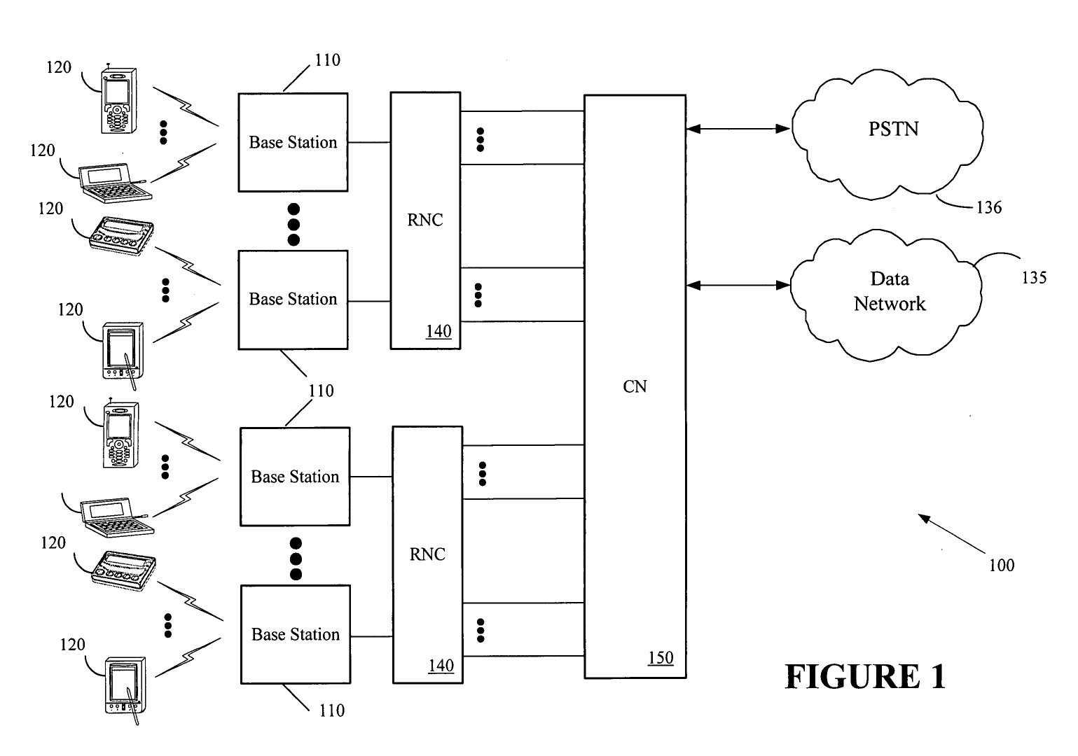

Turning now to the drawings, and specifically referring to FIG. 1, a communications system 100 is illustrated, in accordance with one embodiment of the present invention. For illustrative purposes, the communications system 100 of FIG. 1 is a Universal Mobile Telephone System (UMTS), although it should be understood that the present invention may be applicable to other systems that support data and/or voice communication. The communications system 100 allows one or more mobile devices 120 to communicate with a data network 135, such as the Internet, and/or a public telephone system (PSTN) 136 through one or more base stations 110. The mobile device 120 may take the form of any of a variety of devices, including cellular phones, personal digital assistants (PDAs), laptop computers, digital pagers, wireless cards, and any other device capable of accessing the data network 135 and/or the PSTN 136 through the base station 110.

In one embodiment, a plurality of the base stations 110 may be coupled to a Radio Network Controller (RNC) 140 by one or more connections, such as T1/EI lines or circuits, ATM circuits, cables, optical digital subscriber lines (DSLs), Ethernet/GigabitEthernet links, and the like. Although two RNCs 140 are illustrated, those skilled in the art will appreciate that more RNCs 140 may be utilized to interface with a large number of base stations 110. Generally, the RNC 140 operates in coordination with the base stations 110 to which it is connected with the aid of agent software (not shown) in the RNC 140 and agent software (not shown) in the base station 110. The RNC 140 generally provides replication, communications, runtime, and system management services, and, may be involved in coordinating the transition of the mobile device 120 during transitions (e.g., soft handoffs) between the base stations 110. Although the instant invention is described below as being located, at least in part, in the base station 110, those skilled in the art will appreciate that some or all of the functionality attributed to the base stations 110 may be located in the RNC 140 without departing from the spirit and scope of the instant invention.

The RNCs 140 are also coupled to a Core Network (CN) 150 via a connection, which may take on any of a variety of forms, such as T1/EI lines or circuits, ATM circuits, cables, optical digital subscriber lines (DSLs), Ethernet/GigabitEthernet links, and the like. Generally the CN 150 operates as an interface to the data network 135 and/or to the public telephone system (PSTN) 136. The CN 150 may perform a variety of functions and operations, such as user authentication, however, a detailed description of the structure and operation of the CN 150 is not necessary to an understanding and appreciation of the instant invention. Accordingly, to avoid unnecessarily obfuscating the instant invention, further details of the CN 150 are not presented herein. However, those skilled in the art will appreciate that some or all of the functionality attributed to the base stations 110 may be located in the CN 150 without departing from the spirit and scope of the instant invention.

Thus, those skilled in the art will appreciate that the communications system 100 enables the mobile devices 120 to communicate with the data network 135, the PSTN 136 and/or one another. It should be understood, however, that the configuration of the communications system 100 of FIG. 1 is exemplary in nature, and that fewer or additional components may be employed in other embodiments of the communications system 200 without departing from the spirit and scope of the instant invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

In one embodiment of the instant invention, an accurate, precision power source is used to calibrate the base station 110. The source may be incorporated into the design of the base station's RF path, such that its use can be invoked by the base station 110 on an as needed basis, without requiring disconnection or a separate calibration procedure using external equipment. Instead of requiring tables to calibrate the power detectors, the receiver chain can be recalibrated using the apriori known level of the calibrated source. The cost of a precision calibration source is generally less than an accurate receiver. In this manner, a separate, automated calibration procedure can be incorporated into an easy to invoke diagnostic mode, requiring reduced, or in some cases no, technician intervention. Also, many of the non-volatile memory elements within the units can be eliminated, because the calibration procedure can now be performed more easily on an as needed basis by the base station and its software. The system level calibration architecture using the calibration source is substantially the same for all frequency band and air interface applications (e.g., Cellular, PCS, IMT, and CDMA & UMTS). In the test and measurement industry, the use of a calibration source is a common practice in making accurate power measurements with RF power measurement test equipment.

This calibration source may be incorporated at any of a variety of locations in the RF path, or even multiple calibrators in multiple locations, if there is a requirement for high accuracy for several different functions (such as output power level monitoring and control for baseband predistortion.) Likewise the manner of use of the calibration source (e.g., a CW tone at one frequency, a tone tuned over a range of frequencies, a pulsed tone, a coded waveform, a swept tone, an out-of-TX-band tone, a low level tone, etc.) may be used to achieve different calibration functions and also have different impacts on overall system operation during the automated calibration procedure.

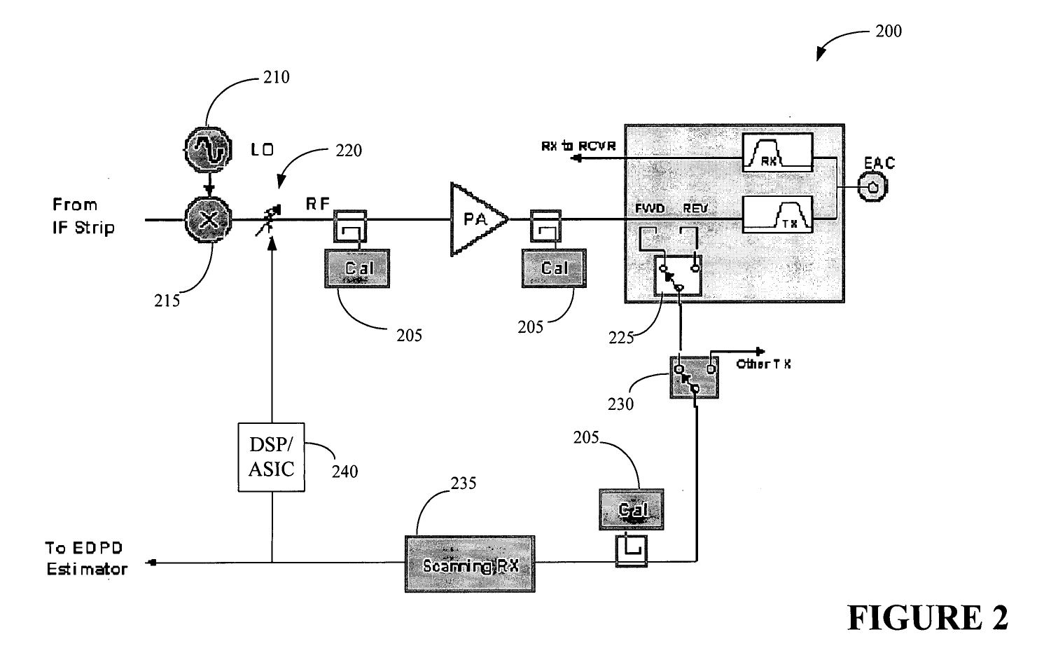

Referring now to FIG. 2, a block diagram of one embodiment of a functional structure associated with an exemplary base station 110 is shown. The base station 110 includes an RF signal generator 200 that has calibration circuitry 205 included therein. The calibration circuitry 205 is shown disposed at three various locations within the RF signal generator 200; however, it should be appreciated that these three locations are exemplary in nature, in that they illustrate various locations in which the calibration circuitry could be deployed without affecting the spirit and scope of the instant invention. In practice, the calibration circuitry 205 may deployed in only one of the three exemplary locations.

Generally, the RF signal generator 200 includes an upconverter comprised of a local oscillator 210 that produces a desired carrier frequency in the RF range. The local oscillator 210 is coupled to a mixer 215. The mixer 215 is also coupled to receive an intermediate frequency signal that is to be modulated onto the carrier signal. An output terminal of the mixer 215 is coupled to a voltage variable attenuator 220. A feedback signal based, at least in part, upon the calibration circuitry 205 may be delivered to the voltage variable attenuator 220 to control the power of the RF signal to a desired level.

During calibration periods, a pair of switches 225, 230 are set to couple the RF signal to a scanning receiver 235. As discussed in more detail below, the scanning receiver 235 is a conventional device commonly present in RF signal generators of base stations, and has heretofore been employed in controlling enhanced digital pre-distortion. The scanning receiver 235 operates to detect the power level of the RF signal being delivered by the base station 110. The RF signal at various times will be the RF signal produced by the mixer 215, and at other times the calibration circuitry 205 will be enabled to produce an RF signal having a known power magnitude. As discussed in more detail below, the difference between these two power signals may be used by a DSP/ASIC to produce the feedback signal that affects the operation of the voltage variable attenuator 220.

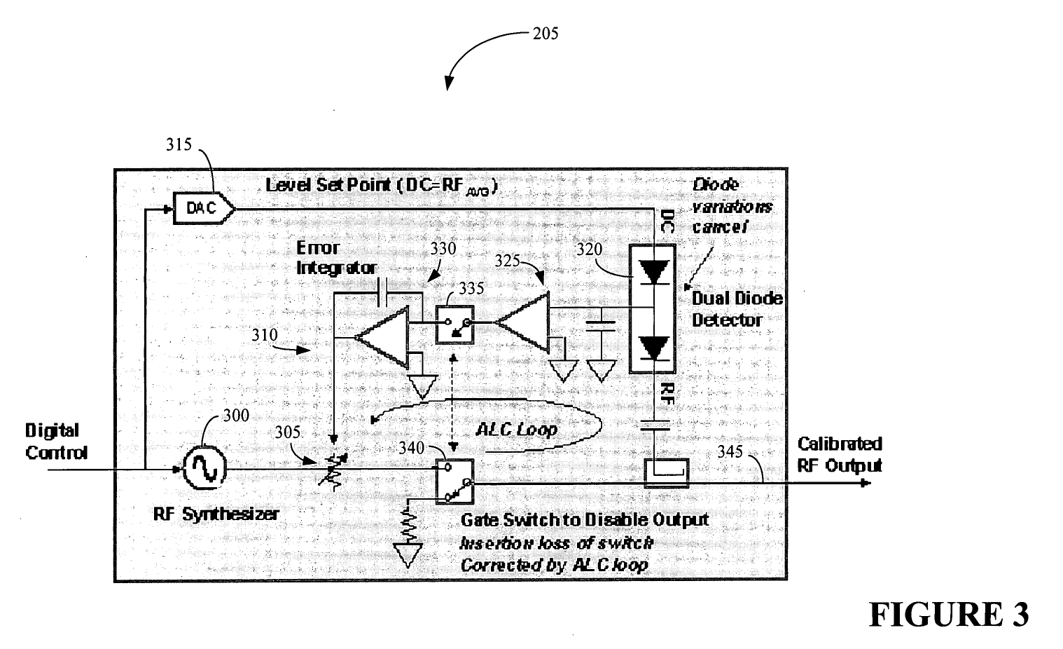

Turning now to FIG. 3, a more detailed block diagram of the calibration circuit 205 is shown. A digital control signal is coupled to an RF synthesizer 300. The digital control signal may be set to control the frequency of the calibration signal produced by the calibration circuit 205. In some embodiments of the instant invention, it may be useful to produce a calibration signal having a frequency outside of the frequency range associated with the local oscillator 210. In other embodiments of the instant invention it may be useful to cause the RF synthesizer 300 to produce a plurality of different frequency signals at different times, such as by sweeping the frequency through a preselected range. The digital control signal will permit such variations in the frequency of the RF synthesizer.

The output signal of the RF synthesizer 300 is passed through a voltage variable attenuator 305, which may be controlled by a feedback loop 310 to control the magnitude of the calibration signal to a desired level.

The digital control signal is also delivered to a Digital to Analog Converter (DAC) 315, which produces a controlled analog signal that is coupled to a dual diode detector 320. The dual diode detector 320 is also coupled to receive the calibration signal. The dual diode detector 320 operates to compare the analog signal produced by the DAC 320 to the RF calibration signal. When the signals match, the dual diode detector 320 delivers an output signal that is substantially zero to a sample and hold circuit 325. When there is a difference between the analog control signal and the calibration signal, the dual diode detector delivers an error signal that has a magnitude related to the difference. The sample and hold circuit 325 saves this error signal and delivers it to an integrator 330 through a controllable switch 335. The integrator 330 accumulates the error signal and drives the voltage variable attenuator 305 to adjust the magnitude of the RF calibration signal so as to reduce the error signal. In this manner the feedback loop 310 adjusts the RF calibration signal to a desired level related to the digital control signal.

In some applications of the instant invention, it may be useful to turn the calibration circuit 205 off. In the illustrated embodiment, a pair of controllable switches 335, 340 are included. The controllable switch 335 is disposed between the integrator 330 and the sample and hold circuit 325. The controllable switch 340 is coupled between the voltage variable attenuator 305 and an output terminal 345 of the calibration circuit 205. Operating the controllable switch 340 couples the output terminal 345 to ground, effectively eliminating the calibration signal. The controllable switch 335 is useful to isolate the integrator 330 from the sample and hold circuit 325 while the calibration signal is off. That is, while the calibration signal is off, the dual diode detector 320 will produce a large error signal that would force the integrator toward its maximum value. Thus, when the switches 335, 340 were controllably moved to their on position, the integrator 330 would be indicating a large difference between the calibration signal and the digital control signal, even though the error may actually be small. Isolating the integrator 330 causes it to remain at about its present value until the switches 335, 340 are controllably turned on again.

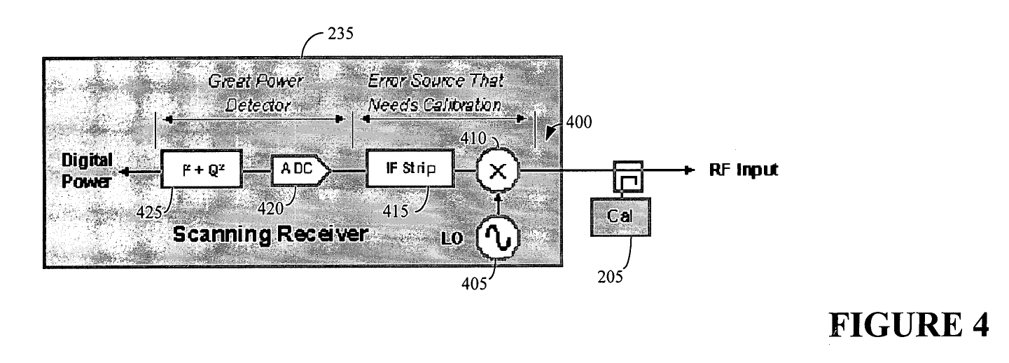

Turning now to FIG. 4, a more detailed block diagram of the scanning receiver 235 is shown. As discussed above, the scanning receiver 235 is a conventional device commonly employed in base stations 110. The scanning receiver 235 is comprised of a downconverter 400 that receives an RF signal either from the calibration circuit 205 or from the attenuator 220. The downconverter 400 is comprised of a local oscillator 405 set to a desired intermediate frequency and a mixer 410. Generally, the downconverter 400 takes the RF signal and converts it to an intermediate frequency. The intermediate frequency signal is delivered to an intermediate frequency strip 415, which includes a band pass limited amplified stage. An Analog to Digital Converter (ADC) 420 translates the analog intermediate frequency signal to a digital signal and delivers the digital signal to a power measurement circuit (I2+Q2) 425. The power measurement circuit 425 produces a signal indicative of the magnitude of the RF signal.

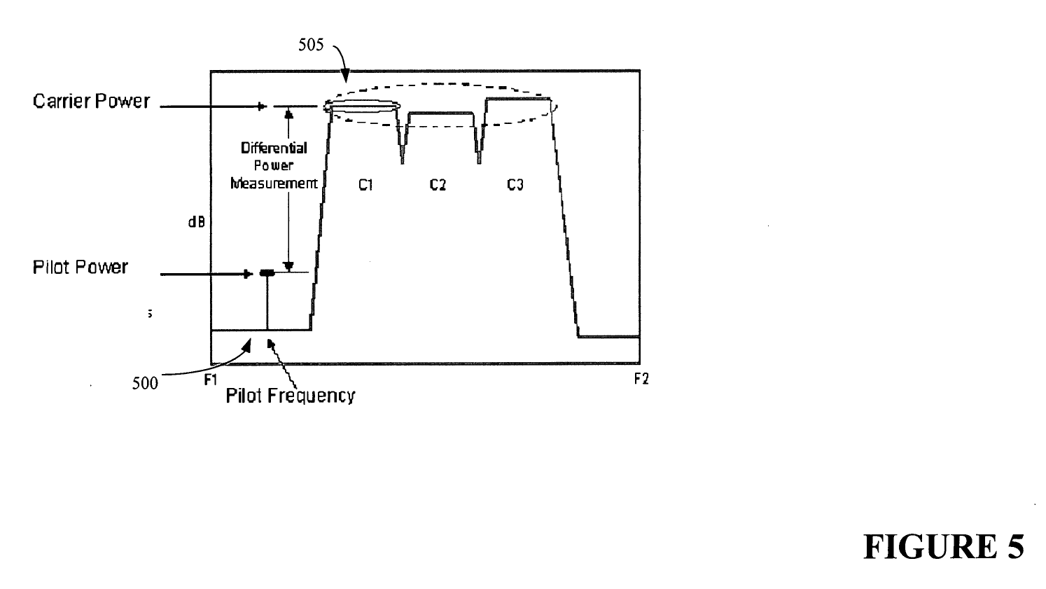

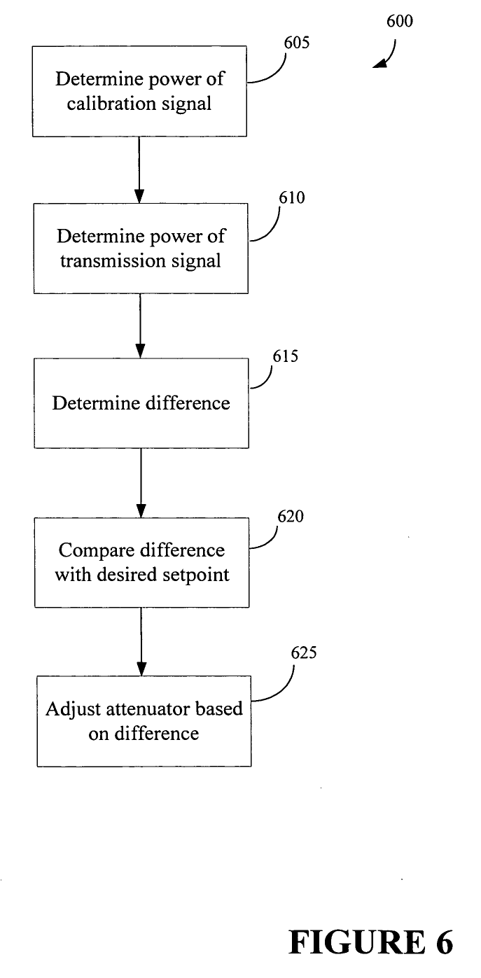

The operation of the DSP/ASIC 240 may be appreciated by simultaneous reference to FIGS. 5 and 6. FIG. 5 is a graph of signal power versus frequency, which corresponds to the signal produced by the scanning receiver 235 and delivered to the DSP/ASIC 240. FIG. 6 is a flow chart illustrating the operation of the DSP/ASIC 240.

The operation of the DSP/ASIC 240 begins at block 605 (see FIG. 6) with a determination of the magnitude of the power of the calibration signal. In the embodiment disclosed in FIG. 5, the magnitude of the calibration signal 500 is shown to be at a frequency displaced from the transmission signal 505 produced by the attenuator 220 and is at a substantially reduced magnitude. Similarly, at block 610 the magnitude of the power of the transmission signal is determined. In the embodiment disclosed in FIG. 5, the transmission signal 505 is shown to have three different carrier frequencies. Those skilled in the art will appreciate that the transmission signal may be composed of one or more carrier frequencies, depending upon the application. The power of the transmission signal 505 may be determined in any of a variety of ways without departing from the spirit and scope of the instant invention (e.g., average, total, mean, etc.).

At block 615, the difference between the magnitude of the calibration signal 500 and the transmission signal 505 is determined. The difference between these signals is then used to control the attenuator 220. At block 620, the determined difference is compared to a preselected setpoint. At block 620, variations between the determined difference and a desired difference are then used to adjust the attenuator 220.

While the operation of the DSP/ASIC 240 is described herein in the context of a flowchart, those skilled in the art will appreciate that the DSP/ASIC 240 may take the form of software, hardware, or a combination of hardware and software and still produce the functionality attributed to it without departing from the spirit and scope of the instant invention.

Those skilled in the art will appreciate that the methodology described herein may be accomplished by software operating in a computing device, by hardware, or by a combination of hardware and software. Further, a controller programmed or designed to provide the functionality described herein may be located wholly, or at least partially, at various cites in the communications system 100, such as in the base station 110, the RNC 140, the CN 150, etc.

Those skilled in the art will appreciate that the various system layers, routines, or modules illustrated in the various embodiments herein may be executable control units. The controllers may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the controllers 210, 250 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for controlling a radio frequency generator, comprising:
determining a first power level of a radio frequency transmission;
determining a second power level of a calibration transmission; and
adjusting the first power level based on a difference between the first and second power levels.

2. A method, as set forth in claim 1, wherein determining the first power level of a radio frequency transmission further comprises measuring the first power level of the radio frequency transmission.

3. A method, as set forth in claim 2 wherein measuring the first power level of the radio frequency transmission further comprises measuring the first power level of the radio frequency transmission using a scanning receiver.

4. A method, as set forth in claim 1, wherein determining the second power level of the calibration transmission further comprises measuring the second power level of the calibration transmission.

5. A method, as set forth in claim 1, further comprising producing the calibration transmission using a source of radio frequency power having a known magnitude.

6. A method, as set forth in claim 1, wherein adjusting the first power level based on the difference between the first and second power levels further comprises:
determining the difference between the first and second power levels;
comparing the determined difference to a desired difference; and
controlling the first power level based on a variation between the determined and desired differences.

7. A method for controlling a radio frequency generator, comprising:
transmitting a first radio frequency signal;
transmitting a second radio frequency signal, said second radio frequency signal being a calibration signal having a power level of a preselected magnitude; and
adjusting a power level of the first radio frequency signal based on a difference between the power levels of the first and second radio frequency signals.

8. A method, as set forth in claim 7, further comprising measuring the power level of the first radio frequency signal.

9. A method, as set forth in claim 8 wherein measuring the power level of the first radio frequency transmission further comprises measuring the power level of the first radio frequency signal using a scanning receiver.

10. A method, as set forth in claim 7, further comprising measuring the second power level of the second radio frequency signal.

11. A method, as set forth in claim 7, wherein adjusting the power level of the first radio frequency signal based on a difference between the power levels of the first and second radio frequency signals further comprises:
determining the difference between the power levels of the first and second radio frequency signals;
comparing the determined difference to a desired difference; and
controlling the power level of the first radio frequency signal based on a variation between the determined and desired differences.

12. A radio frequency generator, comprising:
a first radio frequency source;
a second radio frequency source, the second radio frequency source being calibrated to provide a radio frequency signal having a power level of a predetermined magnitude;
a receiver adapted to determine a power level of the first and second radio frequency sources; and
a feedback controller adapted to adjust the power level of the first radio frequency source based on a difference between the power levels of the first and second sources.

13. A radio frequency generator, as set forth in claim 12, wherein the second radio frequency source has a feedback loop to controllably maintain the power level of radio frequency signal at the predetermined magnitude.

14. A radio frequency generator, as set forth in claim 12, wherein the receiver is a scanning receiver.

15. A radio frequency generator, as set forth in claim 12, wherein the feedback controller is adapted to:
determine the difference between the magnitude of the power levels of the first and second radio frequency signals;
compare the determined difference to a desired difference; and
control the magnitude of the power level of the first radio frequency signal based on a variation between the determined and desired differences.
